(19) United States
(12) Patent Application Publication
(10) Pub. No.: US 2008/0002580 A1
(43) Pub. Date: Jan. 3, 2008

(54) FEC encoding method, FEC decoding method, and FEC decoding apparatus

(75) Inventors: Hiroshi Kawada, Tokyo (JP); Noriya Sakamoto, Tokyo (JP); Hideaki Haruyama, Fujisawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/638,448

(22) Filed: Dec. 14, 2006

(30) Foreign Application Priority Data
Jun. 28, 2006 (JP) 2006-178568

(51) Int. Cl. H04L 12/26

(52) U.S. Cl. 370/231; 370/412

(57) ABSTRACT

Disclosed is an FEC encoding method, including: sequentially storing payloads each included in sequentially supplied media packets into a buffer memory; detecting whether number of the payloads stored reaches a prescribed number or whether a period of time since the payloads have started to be stored into the buffer memory reaches a certain period of time; when detecting that the number of the payloads reaches the prescribed number, performing FEC operation using the prescribed number of payloads stored to generate first information for FEC; when detecting that the period of time since the payloads have started to be stored into the buffer memory reaches the certain period of time, performing FEC operation using the payloads stored into the buffer memory to generate second information for FEC; and outputting the first and second information together with the media packets corresponding thereto.

### CROSS-REFERENCE TO RELATED APPLICATIONS

This application is based upon and claims the benefit of priority from the prior Japanese Patent Application No. 2006-178568, filed on Jun. 28, 2006; the entire contents of which are incorporated herein by reference.

### BACKGROUND

1. Field of the Invention

The present invention relates to an FEC encoding method, an FEC decoding method, and an FEC decoding apparatus for recovering a packet loss occurring when stream information is transmitted in packets, such as, an FEC encoding method, an FEC decoding method, and an FEC decoding apparatus suitable for the case in which the supply density of packets varies over time.

2. Description of the Related Art

FEC (forward error correction) is often used as a technique of recovering on a receiving end a partial loss during transmission of packets (media packets) generated to transmit stream data such as video and audio over a network.

For example, in information transmission using FEC, loss recovery specifications are set for a group of media packets, so that the FEC operation is performed using the information of the group of media packets to generate a corresponding number of FEC packets to the loss recovery ability. More specifically, for example, 20 FEC packets are generated for 100 media packets on the encoding end, and both kinds of packets are outputted to the network.

Generation of the aforementioned FEC packets is not completely finished until a prescribed number of (100 in the above-described example) media packets are supplied. Therefore, the packets cannot be outputted to the network until the media packet necessary for the FEC operation are provided, which may cause a delay. Besides, if the media packets are supplied at a fixed density over time, the output to the network is also at a fixed rate, but if the supply density of the media packets varies over time, the delay increases with a lower density, so that the intervals between outputs to the network may become irregular to be greater than the intervals between the original media packets, resulting in packet outputs in a burst form (block form).

Concrete examples of the supply density of the media packets varying over time include the case of video and audio stream encoded at VBR (variable bit rate), and the case in which redundant portion of data is omitted for reducing the load on the network in retransmission of digital broadcasting software over the network (for example, in the case without null in MPEG2-TS).

Both the aforementioned cases present effects of suppressing the average band on the network but tend to cause overflow or underflow in the buffer memory when using the above-described FEC because the packets in a burst form are received on the receiving end. If the overflow or underflow occurs, the video and audio are broken. To prevent the breakage, a conceivable approach is to increase the capacity of the buffer memory, but the approach increases the period of time to reach to actual reproduction, leading to problematic delay and operability.

Note that conventional arts relating to the present invention include those described in the following Patent Documents 1 and 2. The disclosure of the documents has no discussion on detection whether a period of time since the payloads of the media packets have started to be stored into the buffer memory reaches a certain period of time or on performance of any processing in the state at the point in time of detection.

[Patent Document 1] JP-A 2005-136546 (KOKAI)

[Patent Document 2] JP-A 2001-86153 (KOKAI)

### SUMMARY

An object of the present invention is to provide an FEC encoding method, an FEC decoding method, and an FEC decoding apparatus for recovering a packet loss occurring when stream information is transmitted in packets, which are capable of avoiding outputs in a burst form even when the supply density of packets varies over time.

An FEC encoding method that is one aspect of the present invention includes: sequentially storing respective payloads included in sequentially supplied media packets into a buffer memory; detecting whether the number of the payloads stored into the buffer memory reaches a prescribed number or whether a period of time since the payloads have been able to start to be stored into the buffer memory reaches a certain period of time; when detecting that the number of the payloads stored into the buffer memory reaches the prescribed number, performing FEC operation using the prescribed number of payloads stored into the buffer memory to generate first information for FEC; when detecting that the period of time since the payloads have been able to start to be stored into the buffer memory reaches the certain period of time, performing FEC operation using the payloads stored into the buffer memory to generate second information for FEC; outputting the first information together with the media packets corresponding to the first information; and outputting the second information together with the media packets corresponding to the second information.

In other words, in the FEC encoding method, a prescribed number of media packets for FEC operation are supplied so that the first information for FEC is generated and the following processing may be additionally performed. More specifically, when a period of time since the payloads of the media packets have been able to be started to be stored into the buffer memory reaches a certain period of time, the FEC operation is performed using the payloads stored until then to generate the second information for FEC. Then, the first information is outputted together with the media packets corresponding to the first information, and the second information is outputted together with the media packets corresponding to the second information.

Accordingly, the FEC operation may be performed in the certain period of time even before a prescribed number of payloads are stored into the buffer memory, and the second information that is the operation result may be sequentially outputted together with the media packets corresponding thereto. Therefore, even if the supply density of the original media packets varies over time, the outputs in a burst form can be avoided.

Further, an FEC decoding method that is another aspect of the present invention includes: sequentially storing respective payloads included in sequentially received media packets at first locations in a buffer memory; sequentially storing received information for FEC attached to a group of the media packets at second locations different from the first locations in the buffer memory; detecting the number of packets of the group of the media packets from the information for FEC stored at the second locations in the buffer memory; detecting whether a loss occurs in a portion of the payloads to be stored at the first locations in the buffer memory when a corresponding number of payloads to the number of the detected packets are stored at the first locations in the buffer memory; and when a loss occurs in a portion of the payloads to be stored at the first locations in the buffer memory, performing FEC operation using existing payloads stored at the first locations in the buffer memory and the information for FEC stored at the second locations to recover the loss.

This FEC decoding method is a decoding method corresponding to the above-described FEC encoding method. More specifically, the number of media packets in a group is detected from the information for FEC stored at the second locations in the buffer memory. When a corresponding number of payloads to the detected number of packets are stored at the first locations in the buffer memory, whether a loss occurs in a portion of the payloads to be stored at the first locations in the buffer memory is detected. Further, when there is a loss, FEC operation is performed using existing payloads stored at the first locations in the buffer memory and the information for FEC stored at the second locations to recover the loss. According to this method, in correspondence with the above-described FEC encoding method, FEC decoding is sequentially performed even for the case in which the information for FEC has been generated using the payloads less than the prescribed number.

Further, an FEC decoding apparatus that is still another aspect of the present invention includes: a buffer memory; a first control unit configured to sequentially store respective payloads included in sequentially received media packets at first locations in the buffer memory; a second control unit configured to sequentially store received information for FEC attached to a group of the media packets at second locations different from the first locations in the buffer memory; a third control unit configured to detect the number of packets of the group of the media packets from the information for FEC stored at the second locations in the buffer memory; a fourth control unit configured to detect whether a loss occurs in a portion of the payloads to be stored at the first locations in the buffer memory when a corresponding number of payloads to the number of the detected packets are stored at the first locations in the buffer memory; and a fifth control unit configured to perform FEC operation, when a loss occurs in a portion of the payloads to be stored at the first locations in the buffer memory, using existing payloads stored at the first locations in the buffer memory and the information for FEC stored at the second locations to recover the loss.

The FEC decoding apparatus is an apparatus including a buffer memory and control units to realize the above-described FEC decoding method.

According to the present invention, it is possible to provide an FEC encoding method, an FEC decoding method, and an FEC decoding apparatus for recovering a packet loss occurring when stream information is transmitted in packets, which are capable of avoiding outputs in a burst form even when the supply density of packets varies over time.

### BRIEF DESCRIPTION OF THE DRAWINGS

FIG. 1 is a block diagram showing an apparatus for implementing an FEC encoding method and an FEC decoding method according to one embodiment.

FIG. 2 is an explanatory view illustrating an example of generating the FEC packets (in the case with supply of a prescribed number of media packets).

FIGS. 3A and 3B are configuration diagrams showing internal data structure examples of the media packet and the FEC packet.

FIG. 4 is an explanatory view illustrating an example of generating the FEC packets (in the case without supply of a prescribed number of media packets).

FIG. 5 is a flowchart illustrating the operation flow of the FEC apparatus (encoding end) shown in FIG. 1.

FIG. 6 is a flowchart illustrating the operation flow of the FEC apparatus (decoding end) shown in FIG. 1.

FIG. 7 is an explanatory view illustrating another example of generating the FEC packets (in the case with supply of a prescribed number of media packets).

FIG. 8 is an explanatory view illustrating another example of generating the FEC packets (in the case without supply of a prescribed number of media packets).

FIG. 9 is an explanatory view illustrating still another example of generating the FEC packets (in the case with supply of a prescribed number of media packets).

FIG. 10 is an explanatory view illustrating yet another example of generating the FEC packets (including the case without supply of a prescribed number of media packets).

FIG. 11 is an explanatory view illustrating an example of generating media packets including FEC redundant data (in the case with supply of a prescribed number of media packets).

FIG. 12 is a configuration diagram showing an internal structure example of the media packet including FEC redundant data.

FIG. 13 is an explanatory view illustrating an example of generating the media packets including FEC redundant data (in the case without supply of a prescribed number of media packets).

FIG. 14 is a flowchart illustrating the operation flow of the FEC apparatus (encoding end) shown in FIG. 1 in correspondence with FIG. 11 and FIG. 13.

FIG. 15 is a flowchart illustrating the operation flow of the FEC apparatus (decoding end) shown in FIG. 1 in correspondence with FIG. 11 and FIG. 13.

### DETAILED DESCRIPTION

### (Explanation of Embodiments)

Embodiments of the present invention will be described with reference to the drawings which are provided for illustration only and not intended to limit the present invention by any means.

A form of the present invention (an FEC encoding method) can be configured such that information on the number of the payloads stored into the buffer memory used in the FEC operation to generate the second information is further added to the second information. According to this form, the number of payloads (except dummy payloads) used in the FEC operation performed on the encoding end can be easily detected on the decoding end.

Further, a form can be configured such that information that the second information is different from the first information is further added to the second information. According to this form, it is possible to easily detect on the decoding end that the FEC operation on the encoding end is not performed using a prescribed number of payloads.

Further, a form can be configured such that the generation of the second information is performed by FEC operation using the payloads stored into the buffer memory and dummy payloads padded until the prescribed number is reached. This is a form in which the dummy payloads are padded in the buffer memory to allow the FEC operation to be performed as usual.

It is possible here that when the FEC operation to generate the second information is able to be performed only using the dummy payloads, the FEC operation is not performed so that the second information to be obtained by the FEC operation is not generated. This is to make the generation of the second information for FEC more efficient.

Further, a form can be configured such that both the first and second information are generated as FEC packets independent from the media packet. This is a form in which the first and the second information obtained by the FEC operation are sent as packets.

Further, a form can also be configured such that both the first and second information are added to media packets corresponding to the first and the second information respectively. This is a form in which the first and the second information obtained by the FEC operation are added to the media packets.

A form of the present invention (an FEC decoding apparatus) can be configured such that the fifth control unit pads a dummy payload at the first location in the buffer memory where the loss has not occurred and no payload has been stored and performs the FEC operation. This is a form in which the FEC operation is performed in correspondence with the padding of the dummy payload on the encoding end.

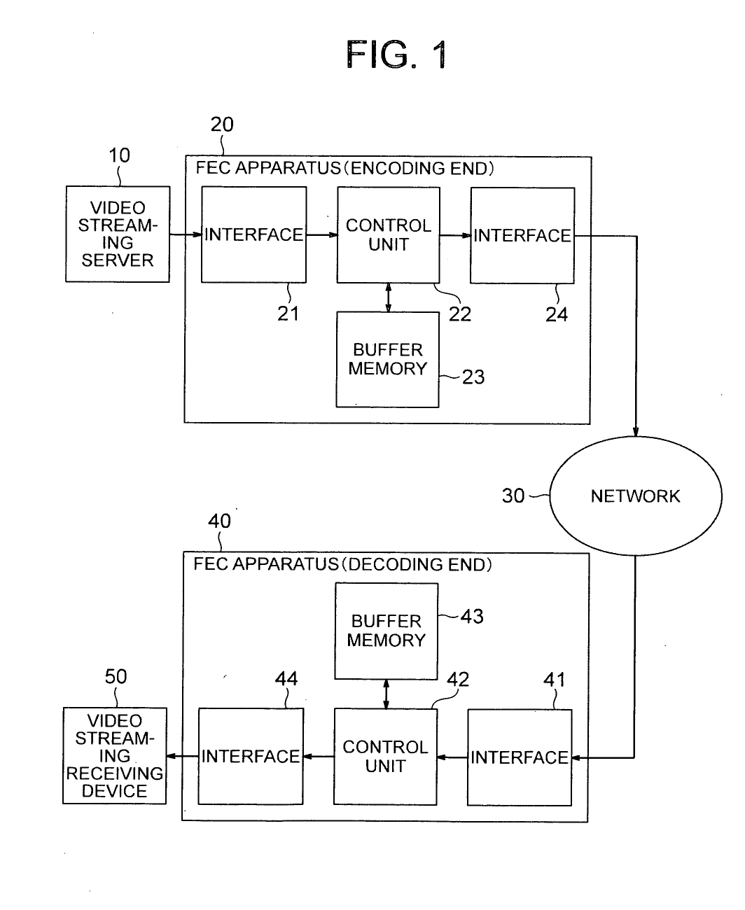

Based on the above, embodiments of the present invention will be described hereinafter with reference to the drawings. FIG. 1 is a block diagram showing a configuration of an apparatus for implementing an FEC encoding method and an FEC decoding method according to one embodiment of the present invention. Information is fed from a video streaming server 10 to an FEC apparatus (encoding end) 20, a network 30, an FEC apparatus (decoding end) 40, and a video streaming receiving device 50 in this order, whereby the information such as video is sent from the sending end to the receiving end.

The video streaming server 10 generates media packets (configuration thereof being described later) containing the information such as video and sequentially supplies them to the FEC apparatus (encoding end) 20. The FEC apparatus (encoding end) 20 stores a plurality of the supplied media packets, performs FEC operation (encoding operation) using payload portions of the stored media packets, and generates FEC packets using the operation result as the payload portions of the FEC packets. The media packets and the generated FEC packets are sent to the side of the FEC apparatus (decoding end) 40 and the video streaming receiving device 50 over the network 30. Note that the FEC apparatus (encoding end) 20 may be incorporated in the video streaming server 10.

The network 30 is an information sending path without guarantee such as the Internet. The media packets and the FEC packets outputted from the FEC apparatus (encoding end) 20 may be partially lost during sending over the network 30 according to circumstances.

The FEC apparatus (decoding end) 40 sequentially stores the media packets and the FEC packets sent over the network 30 so that if there is a loss in a portion of the media packets, the apparatus recovers the loss by performing FEC operation (decoding operation) using the payload portions of remaining media packets and the payload portions of the FEC packets. The media packets obtained by the recovery and the stored media packets are supplied to the video streaming receiving device 50. The video streaming receiving device 50 reproduces video signals and audio signals from the supplied media packets for display or audio output. Note that the FEC apparatus (decoding end) 40 can also be incorporated in the video streaming receiving device 50.

The FEC apparatus (encoding end) 20 has an interface 21, a control unit 22, a buffer memory 23, and an interface 24.

The interface 21 is an interface to receive the media packets supplied from the video streaming server 10 and send them to the control unit 22. The control unit 22 is to perform FEC operation (encoding operation) using the buffer memory 23 as a buffer region. More specifically, the control unit 22 performs processing of sequentially holding the media packets sent via the interface 21, sequentially storing the payload portions in the sequentially held media packets at predetermined locations in the buffer memory 23, performing FEC operation using the payloads stored at the predetermined locations to generate payloads for FEC packets, and generating FEC packets including the generated payloads for FEC packets. The buffer memory 23 has a storage capacity capable of storing all of the payloads required at least for the above-described FEC operation.

The media packets held in and the FEC packets generated by the control unit 22 are outputted from the control unit 22 to the interface 24. The interface 24 is an interface to output the media packets and the FEC packets from the control unit 22 to the network 30.

The FEC apparatus (decoding end) 40 has an interface 41, a control unit 42, a buffer memory 43, and an interface 44.

The interface 41 is an interface to receive the media packets and the FEC packets from the network 30 and supply them to the control unit 42. The control unit 42 is to perform FEC operation (decoding operation) using the buffer memory 43 as a buffer region.

More specifically, the control unit 44 performs processing of sequentially holding the media packets and the FEC packets sent via the interface 41, sequentially storing the payload portions in the sequentially held media packets at first predetermined locations in the buffer memory 43, sequentially storing the payload portions in the sequentially held FEC packets at second predetermined locations in the buffer memory 43, and, when there is a loss in the stored payloads of the media packets, recovering the lost payload by performing FEC operation (decoding operation) using remaining payloads and the payloads of the FEC packets stored at the second locations. The buffer memory 43 has a storage capacity capable of storing all of the payloads required at least for the above-described FEC operation.

The media packets in the control unit 42 including the packet containing the payload obtained by the recovery are outputted from the control unit 42 to the interface 44. The interface 44 is an interface to supply the media packets from the control unit 42 to the video streaming receiving device 50.

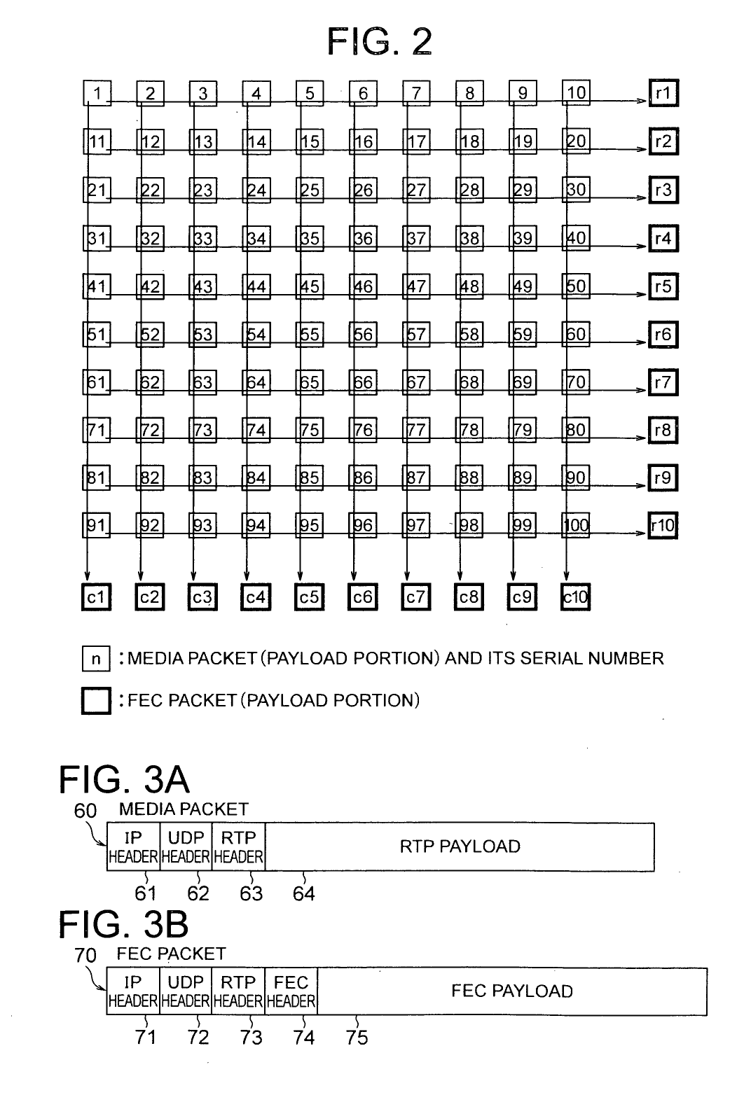

Next, an example of generating the FEC packets in the control unit 22 will be described with reference to FIG. 2. FIG. 2 is an explanatory view illustrating the example of generating the FEC packets (in the case with supply of a prescribed number of media packets).

As shown in FIG. 2, in this example, the payload portions of the media packets are stored into the buffer memory 23 such that ten payloads are arranged in each of latitudinal and longitudinal directions in order of their serial numbers. More specifically, the prescribed number in the FEC operation is 100. The payload portion of the FEC packet is calculated as each one FEC payload (r1 to r10, c1 to c10) using the payloads of ten media packets in each row or each column. In this specification, 20 FEC packets are added for 100 media packets.

In this case, even when there is one loss in any one of every 11 payloads composed of the payloads in each row or each column and each FEC payload added thereto, the one loss can be recovered on the decoding end using the remaining payloads including the FEC payload. Accordingly, for example, when there are two or more losses in a certain row, the losses cannot be recovered first time.

However, in a state in which the two or more losses are recovered by the FEC operation (decoding operation) by each column so that only one loss is in the row, if the FEC operation (decoding operation) by each row is performed again, the one loss can be recovered. More specifically, the decoding corresponding to such FEC operation (encoding operation) includes three FEC operations (decoding operations) in order of each row, each column, and each row (or each column, each row, and each column). Note that description of the FEC operations (encoding operation and decoding operation) will be omitted since several modes for the operations are well known and can be used.

FIGS. 3A and 3B are configuration diagrams showing internal data structure examples of the media packet and the FEC packet. As shown in FIG. 3A, a media packet 60 is composed of a header portion and a payload portion, and the header portion is composed of, for example, an IP header 61, an UDP header 62, and an RTP header 63. The payload portion is an RTP payload 64. The RTP payload 64 is used to generate the payload for the FEC packet.

Further, as shown in FIG. 3B, an FEC packet 70 is composed of a header portion and a payload portion, and the header portion is composed of, for example, an IP header 71, an UDP header 72, an RTP header 73, and an FEC header 74. The payload portion is an FEC payload 75. The FEC payload 75 is generated by operation using a plurality of (10 in the example in FIG. 2) RTP payloads 64 of the media packets (FIG. 3A). The FEC header 74 holds, as described later, information on a predetermined attribute of the FEC operation (encoding operation).

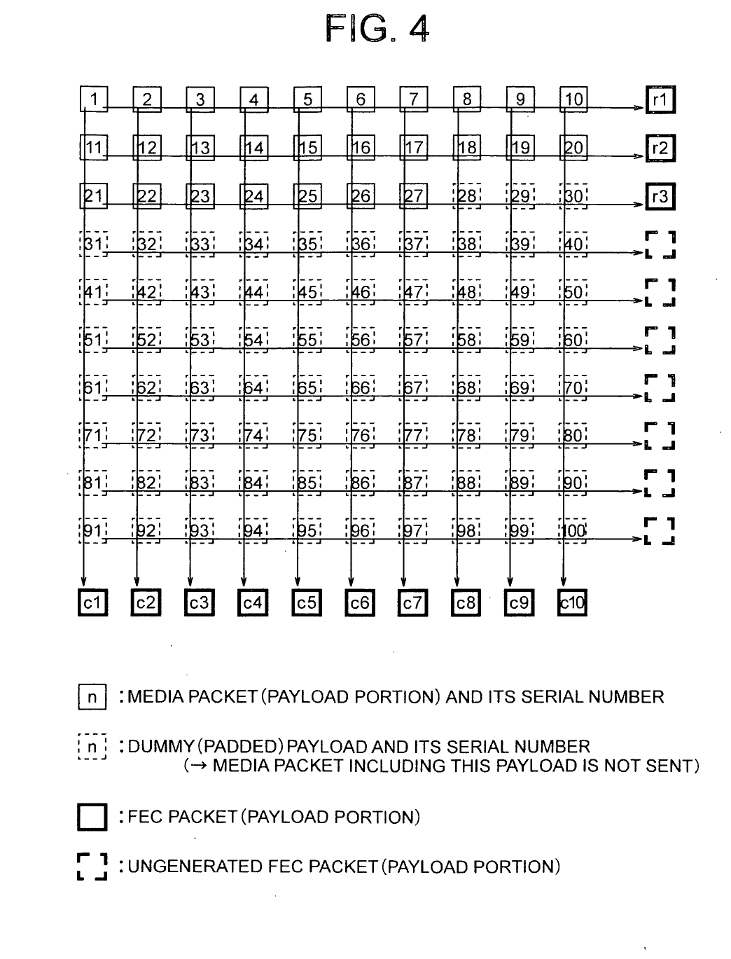

Next, referring to FIG. 4, an example of generating the FEC packets in the control unit 22 will be described in the case in which a prescribed number of media packets are not supplied. FIG. 4 is an explanatory view illustrating the example of generating the FEC packets (in the case without supply of a prescribed number of media packets).

As described with FIG. 2, the prescribed number of media packets to generate the FEC packets is 100 in this example. However, as described later, if a prescribed number of media packets are not supplied to the control unit 22 during a divided certain period of time, the FEC payloads are generated using the payloads of the media packets stored until then.

As shown in FIG. 4, when, for example, 27 media packets less than the prescribed number are now supplied to the control unit 22 until a predetermined time point and their payloads are stored, dummy payloads are added (padded) to the remaining storage regions as illustrated so that the padded payloads are also used to perform operation to generate the FEC payloads. Generation of the FEC payload in each row of an illustrated serial number 31 and thereafter can be omitted here. Because of operation using only the dummy payloads, the result is to be determined, and it is not necessary, as a matter of course, to send the FEC packet including the FEC payload whose generation is omitted. In this case, 13 FEC packets (r1 to r3 and c1 to c10) will be added for 27 media packets.

Generation of the FEC payloads by such processing includes the following advantages. The FEC packets are generated in a divided period of time and the media packets are outputted to the network 30, so that even when the supply density of the original media packets in terms of time is low, the media packets can be sequentially outputted according to the low density. Therefore, the problem of increasing delay in sending with a lower density is solved, and the possibility that the outputted packets form a burst is substantially eliminated.

Further, it is possible not to send the packets generated using padded dummy payloads and the FEC packets generated using only the dummy payloads so as to minimize the increase in average band on the network 30. Moreover, if the FEC packets are generated using the media packets less than the prescribed number, the substantial ability of recovering the loss of the media packets is improved. This is because when the payload information to be padded is determined, the loss can be complemented on the decoding end without the need of recovering the loss, based on which the FEC operation (decoding operation) can also be performed.

Note that while padding of the dummy payloads is described in the foregoing, the storage regions of the payloads may be padded with dummy payloads as their initial states as a modification example. In this case, it is only necessary to rewrite the storage region with the payload of a media packet every time the media packet is supplied. Besides, the FEC packets including the FEC payloads generated by operation using only the dummy payloads may also be sent to the network 30, which never interfere with decoding processing because it is only necessary to discard them on the decoding end, though the average band on the network 30 is somewhat increases.

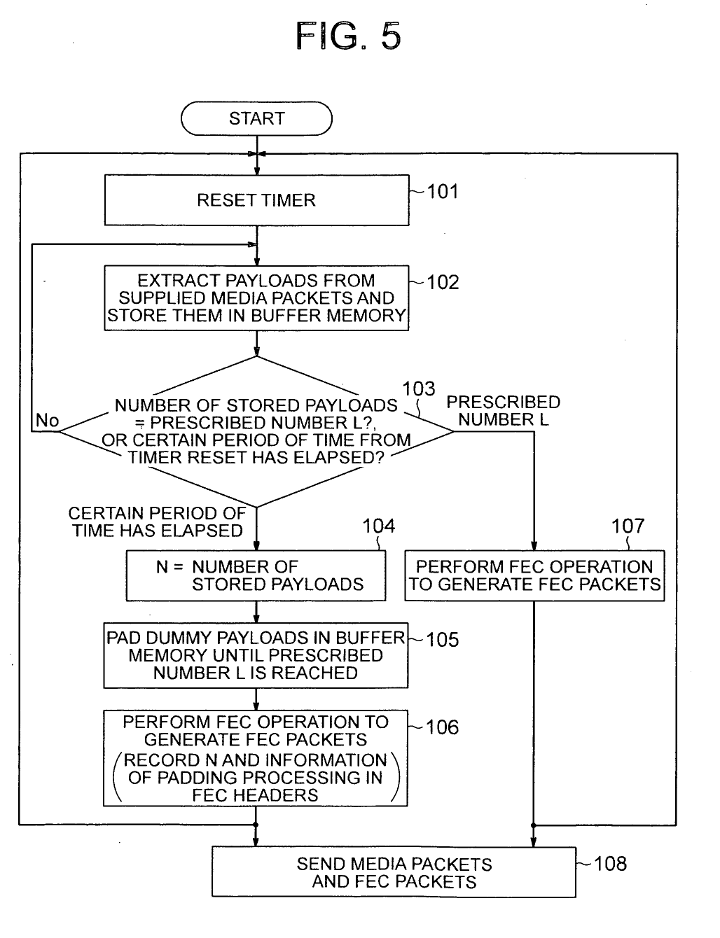

FIG. 5 is a flowchart illustrating the operation flow of the FEC apparatus (encoding end) 20 shown in FIG. 1. The operation flow will be described again over time though somewhat overlapping with the above description.

First, a timer is reset (Step 101). The timer is provided, for example, in the control unit 22. Then, under the control of the control unit 22, payload portions are extracted from the media packets supplied from the video streaming server 10 via the interface 21 and stored into the buffer memory 23 (Step 102). The original media packets are also held.

Whether the number of the stored payloads reaches the prescribed number L or whether a predetermined certain period of time from the timer reset has elapsed is detected under the control of the control unit 22 (Step 103). If either cannot be detected (No in Step 103), the flow returns to Step 102 in which the payload portions of the media packets supplied from the video streaming server 10 are continuously stored into the buffer memory 23.

When the number of the stored payloads reaches the prescribed number L (the “prescribed number” in Step 103), FEC operation (encoding operation) is performed using the payloads stored into the buffer memory 23 to generate the FEC payloads and the FEC packets (Step 107: see FIG. 2). The generated FEC packets are sent to the interface 24 side together with the media packets corresponding thereto (Step 108). In addition, the flow returns to Step 101 and repeats the above-described series of processing.

Besides, when the certain period of time has elapsed from the timer reset (“certain period of time has elapsed” in Step 103), the number of the stored payloads at that time is held as N (Step 104), and dummy payloads are padded in the buffer memory 23 until the number reaches the prescribed number L (Step 105). The padding may be performed in advance as has been described.

Then, the FEC operation (encoding operation) is performed using the payloads stored into the buffer memory 23 and the dummy payloads to generate the FEC payloads and the FEC packets (Step 106: see FIG. 4). It is more preferable that the generated FEC headers of the FEC packets include the aforementioned N and information that the padding processing has been performed (Step 106). If those kinds of information are included in the FEC headers, they can be easily detected on the decoding end. Note that even if such information is not always included in the FEC headers, it is possible to determine N on the decoding end, for example, by discriminating the packets sent as a group based on the information included in each header of each packet and obtaining the total number of packets in the group.

The generated FEC packets are sent to the interface 24 side together with the media packets corresponding thereto (Step 108). In addition, the flow returns to Step 101 and repeats the above-described series of processing.

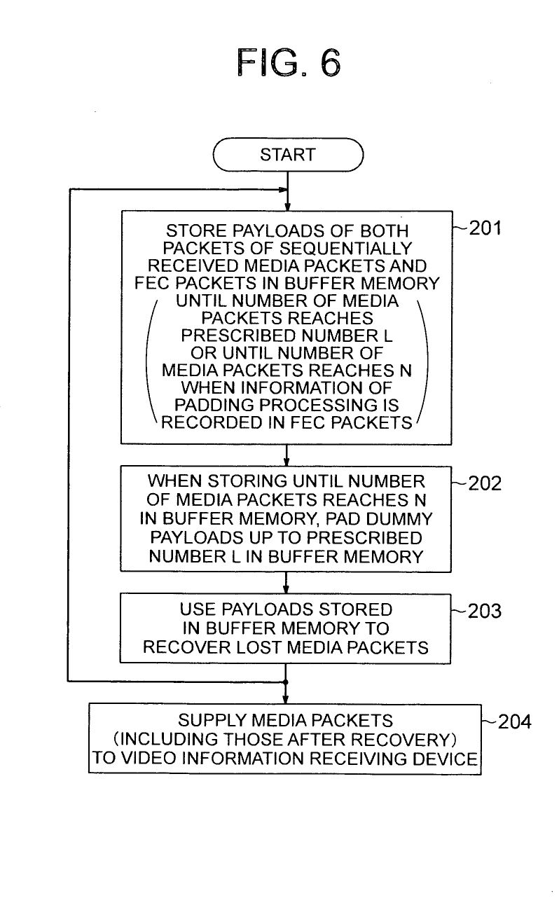

FIG. 6 is a flowchart illustrating the operation flow of the FEC apparatus (decoding end) 40 shown in FIG. 1. The operation flow will be described again over time though also somewhat overlapping with the above description.

First, under the control of the control unit 42, the payload portions of both packets of the sequentially received media packets and FEC packets are stored into the buffer memory 43 (Step 201). The payload portions of the media packets are stored in storage regions for them (first locations), and the payload portions of the FEC packets are stored in storage regions for them (second locations).

The storage at that time is performed until the number of media packets reaches the prescribed number L or until the number of media packets reaches N that is the number whose information are recorded in the FEC headers when the information of the padding processing is similarly included in the FEC headers. However, even if such information is not included in the FEC headers, it is possible to determine N, for example, by discriminating the packets sent as a group based on the information included in each header of each packet and obtaining the total number of packets in the group.

Then, in the case where the storage is performed until the number of media packets reaches N in the buffer memory 43, dummy payloads are padded up to the prescribed number L in the remaining storage regions in the buffer memory 43 (Step 202). The padding may be performed in advance as in encoding.

Then, FEC operation (decoding operation) is performed using the payloads (optionally including those by padding) stored into the buffer memory 43 to recover the lost payloads, thereby recovering the lost media packets (Step 203). The media packets including the media packets whose losses have been recovered are sent via the interface 44 to the video streaming receiving device 50 (Step 204). In addition, the flow returns to Step 201 and repeats the above-described series of decoding processing.

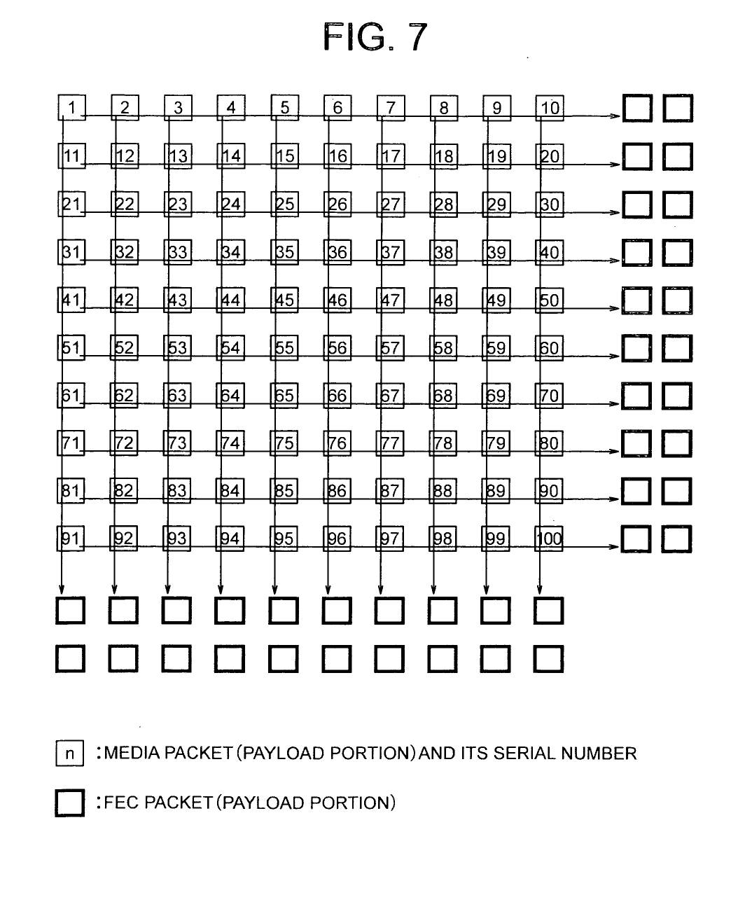

Next, another example of generating the FEC packets in the control unit 22 will be described with reference to FIG. 7. FIG. 7 is an explanatory view illustrating the other example of generating the FEC packets (in the case with supply of a prescribed number of media packets).

In this example, each payload portion of the FEC packet is calculated as two FEC payloads by using ten payloads of media packets in each row or each column for operation. In this specification, 40 FEC packets are added for 100 media packets, and therefore the ability of recovering the packet loss is higher than that described with FIG. 2. More specifically, even when there are up to any two losses of 12 payloads composed of the payloads in each row or each column and the FEC payloads added thereto, the losses can be recovered using remaining payloads including the FEC payloads. Similarly, in another possible specification to improve the ability of recovering the packet loss, ten payloads in each row or each column are used for operation to calculate more than two FEC payloads, thereby generating the FEC packet.

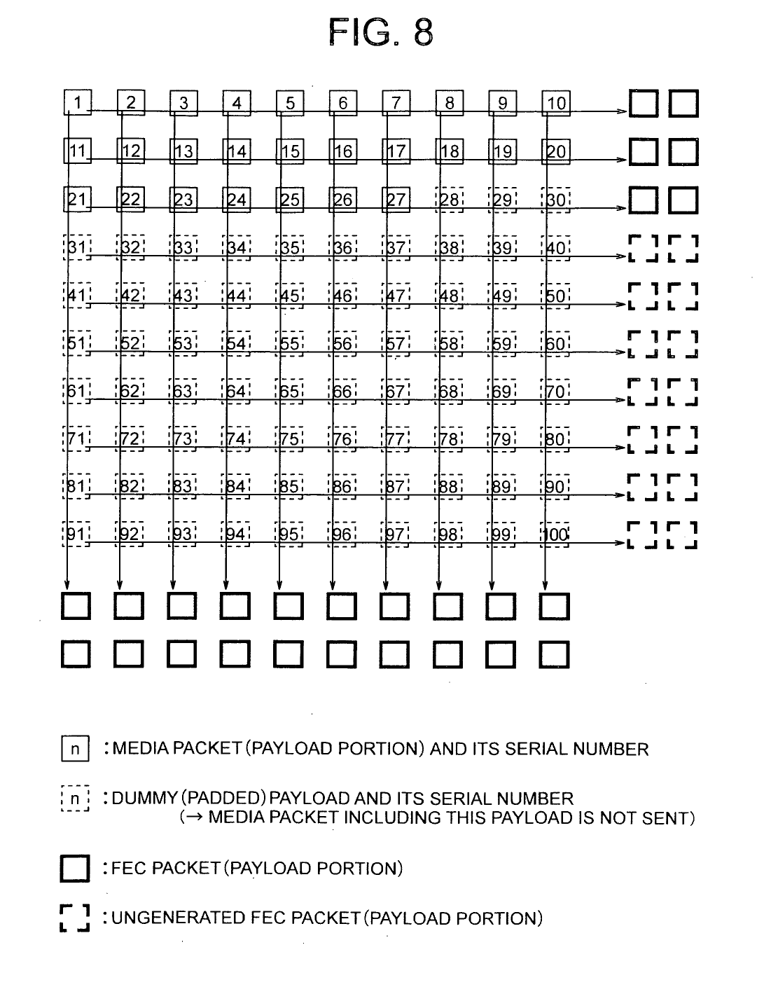

FIG. 8 is an explanatory view illustrating another example of generating the FEC packets (in the case without supply of a prescribed number of media packets). This is an example of generating the FEC packets in the control unit 22 in the case in which the generation of the FEC packets as shown in FIG. 7 is performed but a prescribed number of media packets are not supplied.

Reference to FIG. 4 and FIG. 7 sufficiently illustrates FIG. 8. Namely, the padding of the dummy payloads, the omission of generation of the FEC payloads only by the dummy payloads, and the omission of sending of such FEC packets are as described above. Further, the effects such as the elimination of the possibility of the outputted packets forming a burst, the ability of minimizing the increase in average band on the network 30, and the improvement in the substantial ability of recovering the loss of the media packets when the FEC packets are generated using the media packets less than the prescribed number are also as described above.

In addition, the FEC operation on the decoding end corresponding to the case in which the FEC operation (encoding operation) as shown in FIG. 7 and FIG. 8 is performed can be readily understood referring to the description for FIG. 6 and so forth.

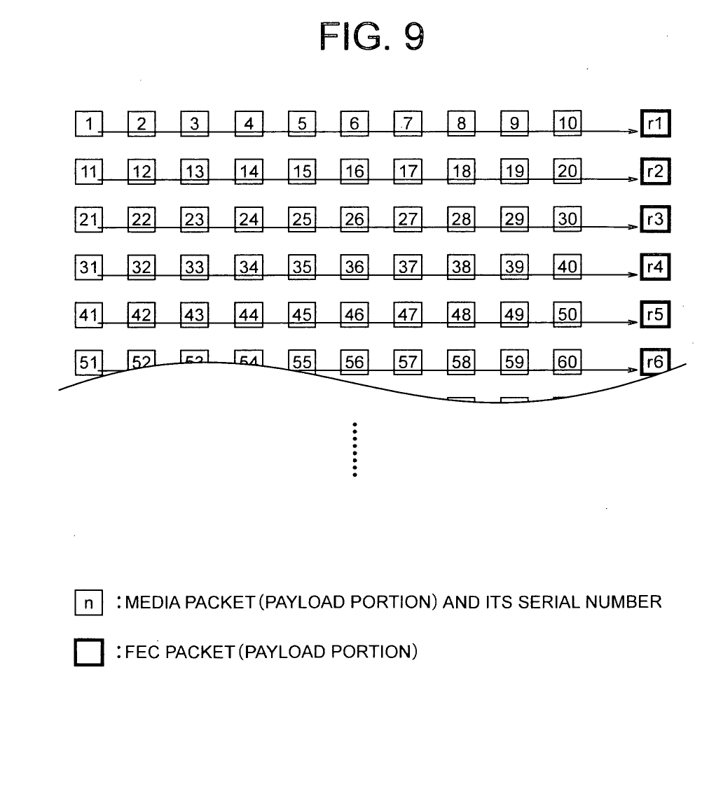

Next, still another example of generating the FEC packets in the control unit 22 will be described with reference to FIG. 9. FIG. 9 is an explanatory view illustrating still another example of generating the FEC packets (in the case with supply of a prescribed number of media packets). In this example, the payload portions of the media packets are stored into the buffer memory 23 such that ten payloads are arranged in order of their serial numbers. Namely, the prescribed number in the FEC operation is 10. The payload portion of the FEC packet is calculated as one FEC payload using the payloads of ten media packets. In this specification, one FEC packet is added for 10 media packets.

In this case, even when there is one loss in any one of 11 payloads composed of the payloads of ten media packets and the FEC payload added thereto, the one loss can be recovered using remaining payloads including the FEC payload. Accordingly, when there are two or more losses in the 11 payloads, the losses cannot be recovered. In this sense, the ability of recovering the loss in this example is less than that in the method of latitudinally and longitudinally generating the FEC payloads as shown in FIG. 2. However, the buffer memory 23 (similarly the buffer memory 43 on the decoding end) can have a small storage capacity and be employable in a simple apparatus.

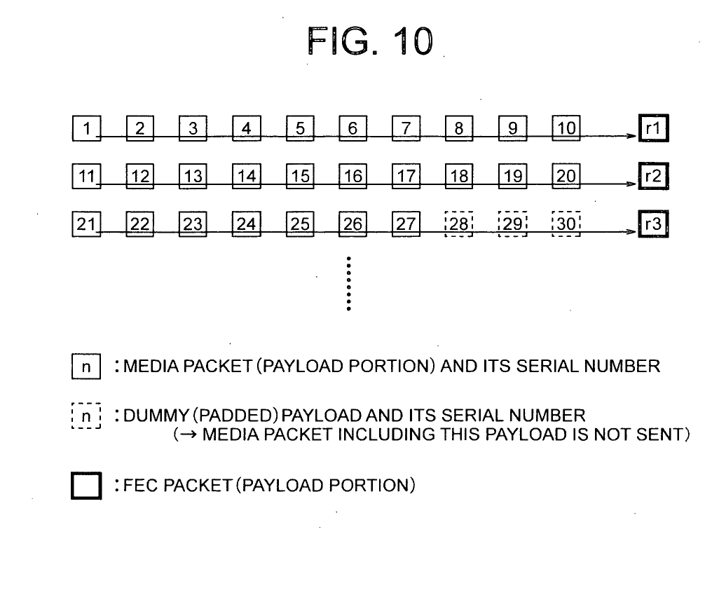

FIG. 10 is an explanatory view illustrating still another example of generating the FEC packets (including the case without supply of a prescribed number of media packets). This is an example of generating the FEC packets in the control unit 22 in the case in which the generation of the FEC packets as shown in FIG. 9 is performed but a prescribed number of media packets are not supplied.

In FIG. 10, the description for FIG. 9 applies to the payload portions of first ten media packets and next ten media packets. For the payloads portions of ten media packets subsequent to them, a prescribed number of media packets are not supplied but 7 media packets are supplied in this case. The other description is sufficiently illustrated by referring to FIG. 9 and FIG. 4. Namely, the padding of the dummy payloads is as described above. Further, the effects such as the elimination of the possibility of the outputted packets forming a burst, the ability of minimizing the increase in average band on the network 30, and the improvement in the substantial ability of recovering the loss of the media packets when the FEC packet is generated using the media packets less than the prescribed number are also as described above.

In addition, the FEC operation on the decoding end corresponding to the case in which the FEC operation (encoding operation) as shown in FIG. 9 and FIG. 10 has been performed can be also readily understood referring to the description for FIG. 6. The FEC operation on the decoding end in this case is employable as simple processing even for the case in which the latitudinal and longitudinal FEC operations (encoding operations) as shown in FIG. 2 and FIG. 4 have been performed on the sending end.

Next, FIG. 11 is an explanatory view illustrating an example of generating media packets including FEC redundant data (in the case with supply of a prescribed number of media packets). In the above-described examples, information to perform FEC is generated in a form of an independent FEC packet. This case employs a form in which information to perform FEC is added to each media packet.

As shown in FIG. 11, in concept, for example, the calculation result of the FEC payloads as shown in FIG. 2 is regarded as in-process data and divided to form redundant data which is added to each of the payloads used for the calculation. These are sent to the network as the encoded result, so that the added FEC redundant data can be collected on the decoding end to reproduce the FEC payloads. The processing after the reproduction is the same as has been described.

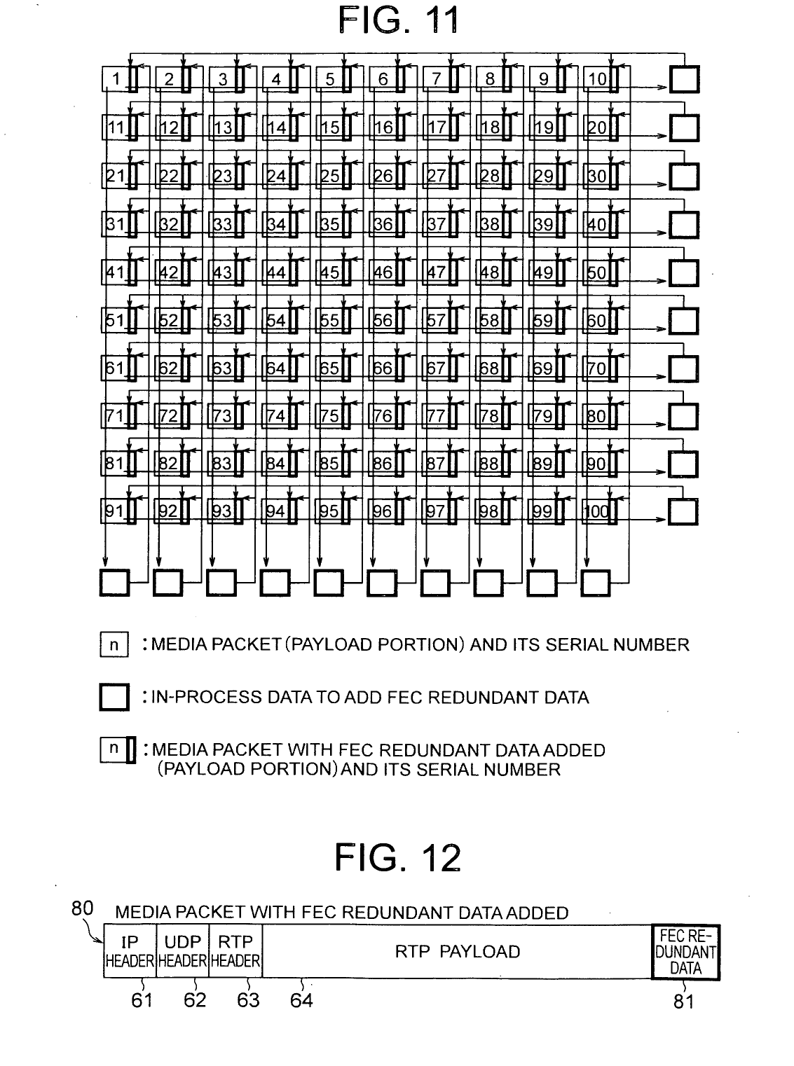

FIG. 12 is a configuration diagram showing an internal structure example of the media packet including such FEC redundant data. As shown in FIG. 12, a media packet 80 with FEC redundant data added is composed of a header portion, a payload portion, and a portion of FEC redundant data 81, and the header portion is composed of, for example, an IP header 61, an UDP header 62, and an RTP header 63. The payload portion is an RTP payload 64. The payloads 64 are used to generate the portion of the FEC redundant data 81.

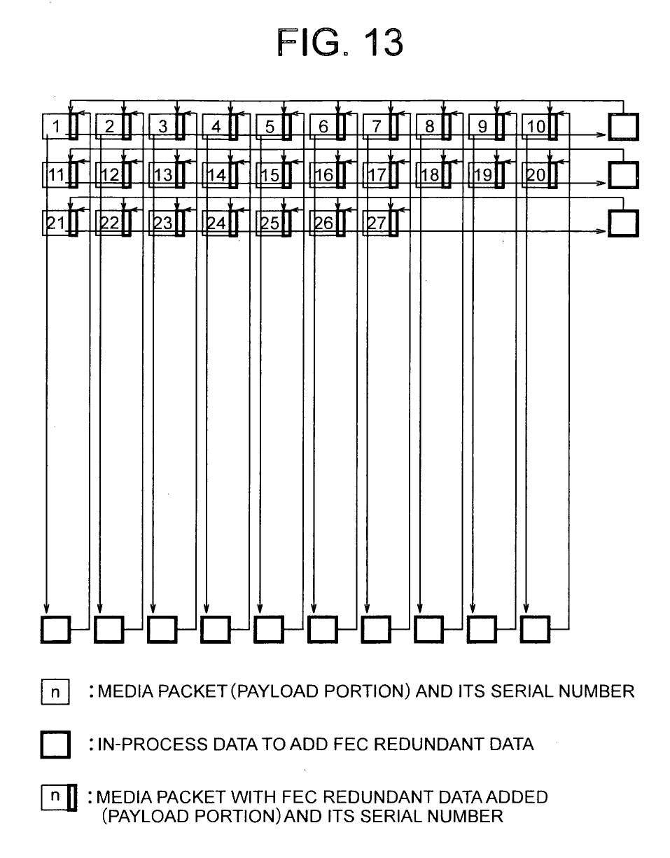

FIG. 13 is an explanatory view illustrating an example of generating the media packets including FEC redundant data (in the case without supply of a prescribed number of media packets). This is an example of generating the packets in the case in which the addition of the FEC redundant data as shown in FIG. 11 is performed but a prescribed number of media packets are not supplied. As shown in FIG. 13, this is an example where, for example, 27 media packets less than the prescribed number are now supplied to the control unit 22 until a predetermined time point and their payloads are stored.

In this case, as shown in the drawing, in-process data is generated for addition of the FEC redundant data using the payloads stored until the prescribed time point. The reason of this is that payloads may be padded to portions required to satisfy the prescribed number so that the padded payloads may also be used to generate in-process data, but in this case the payloads generated by padding are not sending object, failing to addition of the FEC redundant data. More specifically, only the stored payloads are used to calculate in-process data of a smaller size, and the calculated in-process data is divided and added to the stored payloads.

Generation of the media packets (with the FEC redundant data added) by such processing also includes the following advantages. Namely, the FEC redundant data is generated in a divided period of time and the media packets (with the FEC redundant data added) are outputted to the network 30, so that even when the supply density of the original media packets in terms of time is low, the media packets (with the FEC redundant data added) can be sequentially outputted according to the low density. Therefore, the problem of increasing delay in sending with a lower density is solved, and the possibility that the outputted packets form a burst is substantially eliminated. It is also possible to minimize the increase in average band on the network 30.

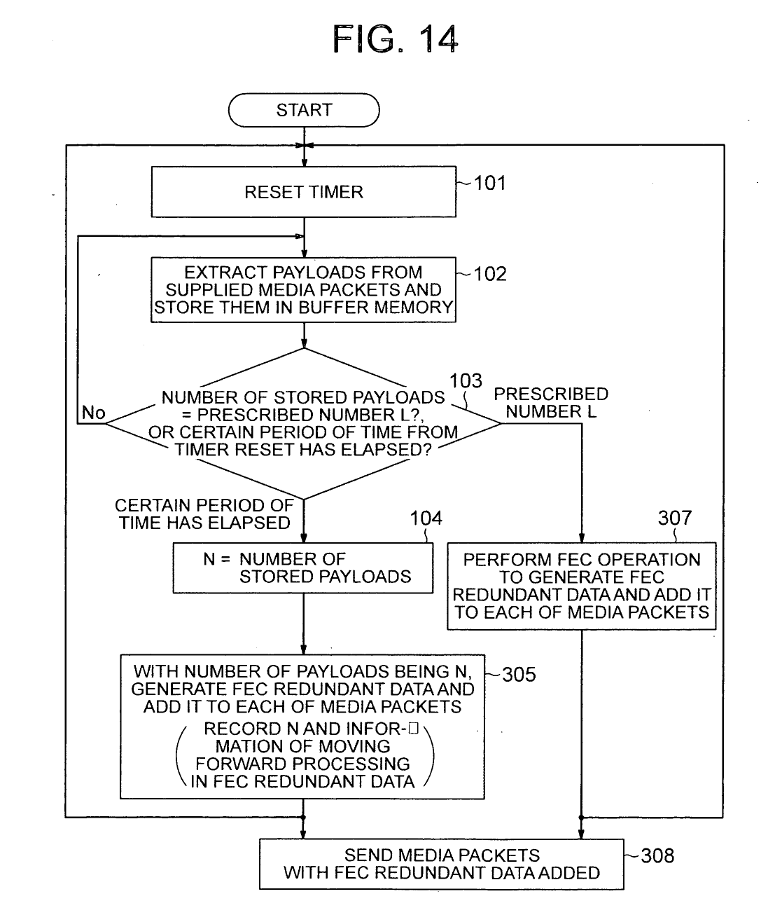

FIG. 14 is a flowchart illustrating the operation flow of the FEC apparatus (encoding end) shown in FIG. 1 in correspondence with FIG. 11 and FIG. 13. The operation flow will be described again over time though somewhat overlapping with the description for FIG. 11 and FIG. 13. Besides, the same numbers and symbols are given to the processing blocks in FIG. 14 which have been already mentioned in FIG. 5. The description for them may be omitted.

Steps 101, 102, 103, and 104 are the same as those in the description in FIG. 5. In Step 103, when the number of the stored payloads reaches the prescribed number L (the “prescribed number” in Step 103), FEC operation (encoding operation) is performed using the payloads stored into the buffer memory 23 to generate the media packets (with the FEC redundant data added) (Step 307: see FIG. 11). The generated media packets (with the FEC redundant data added) are sent to the interface 24 side (Step 308). In addition, the flow returns to Step 101 and repeats the above-described series of processing.

Besides, when the certain period of time has elapsed from the timer reset (“certain period of time has elapsed” in Step 103), the number of the stored payloads at that time is held as N (Step 104), and FEC redundant data is generated and added to each of the media packets (Step 305: see FIG. 13). It is more preferable that the added FEC redundant data includes the aforementioned N and information that the moving forward processing has been performed (Step 305). If those kinds of information are included in the FEC redundant data, they can be easily detected on the decoding end. Note that even if such information is not necessarily included, it is possible to determine N on the decoding end, for example, by discriminating the packets sent as a group based on the information included in each header of each packet and obtaining the total number of packets in the group.

The media packets with the FEC redundant data added are sent to the interface 24 side (Step 308). In addition, the flow returns to Step 101 and repeats the above-described series of processing.

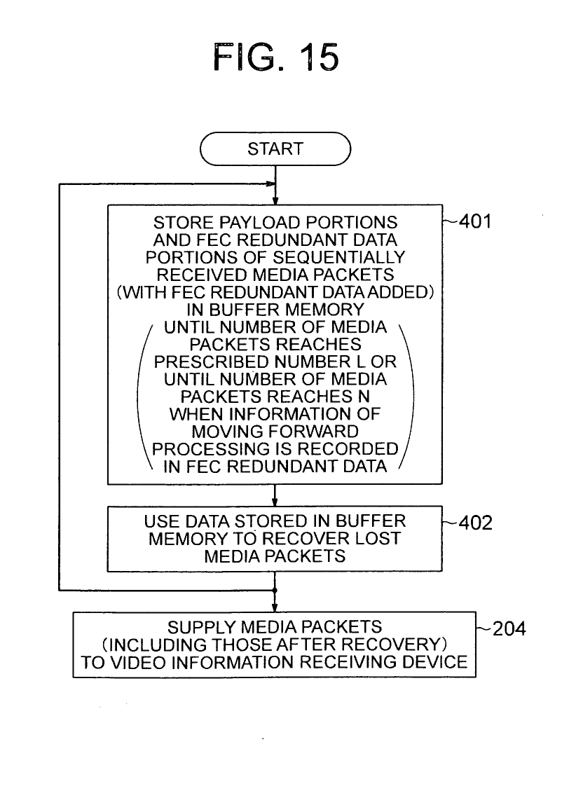

FIG. 15 is a flowchart illustrating the operation flow of the FEC apparatus (decoding end) shown in FIG. 1 in correspondence with FIG. 11 and FIG. 13. The operation flow will be described again over time though also somewhat overlapping with the description for FIG. 11 and FIG. 13. Besides, the same numbers and symbols are given to the processing blocks in FIG. 15 which have been already mentioned in FIG. 6.

First, under the control of the control unit 42, the payload portions and the FEC redundant data portions of the sequentially received media packets (with the FEC redundant data added) are stored into the buffer memory (Step 401). The payload portions are stored in storage regions for them (first locations), and the FEC redundant data portions are stored in storage regions for them (second locations).

The storage at that time is performed until the number of media packets reaches the prescribed number L or until the number of media packets reaches N that is the number whose information are recorded in the FEC redundant data when the information of the moving forward processing is similarly included in the FEC redundant data. However, even if such information is not included in the FEC redundant data, it is possible to determine N, for example, by discriminating the packets sent as a group based on the information included in each header of each packet and obtaining the total number of packets in the group.

Then, FEC operation (decoding operation) is performed using the data stored into the buffer memory 43 to recover the lost payloads, thereby recovering the lost media packets (Step 402). The media packets including the media packets whose losses have been recovered are sent via the interface 44 to the video streaming receiving device 50 (Step 204). In addition, the flow returns to Step 401 and repeats the above-described series of decoding processing.

The embodiments of the present invention have been described and supplemented hereinafter. For the functions of the reception of packets, the FEC operation, and the packet sending in the FEC apparatus (encoding end) 20 and the FEC apparatus (decoding end) 40, a plurality of channels may be provided respectively so that they can be processed in parallel. Further, it is able to determine the prescribed number L, for example, based on the specification of the ability of recovering the packet loss, and to determine the above-described “certain period of time” in consideration, for example, of the information delay time allowable in the video streaming receiving device 50 and the quality of the network 30.

The present invention is not limited to the specific forms described herein with the illustrations, but it is to be understood that all the changes and modifications without departing from the range of the following claims are to be included therein.

What is claimed is:

1. An FEC encoding method, comprising:
sequentially storing payloads each included in sequentially supplied media packets into a buffer memory;
detecting whether number of the payloads stored into the buffer memory reaches a prescribed number or whether a period of time since the payloads have been able to start to be stored into the buffer memory reaches a certain period of time;
performing FEC operation using the prescribed number of payloads stored into the buffer memory to generate first information for FEC, when detecting that the number of the payloads stored into the buffer memory reaches the prescribed number;
performing FEC operation using the payloads stored into the buffer memory to generate second information for FEC, when detecting that the period of time since the payloads have been able to start to be stored into the buffer memory reaches the certain period of time;
outputting the first information together with the media packets corresponding to the first information; and
outputting the second information together with the media packets corresponding to the second information.

2. The method according to claim 1, further comprising:
adding, to the second information, information on the number of the payloads stored into the buffer memory, the payloads being used in the FEC operation to generate the second information.

3. The method according to claim 1, further comprising:
adding, to the second information, information that the second information is different from the first information.

4. The method according to claim 1, wherein the generation of the second information is caused by the FEC operation using the payloads stored into the buffer memory together with dummy payloads padded until the prescribed number is reached.

5. The method according to claim 1, wherein both the first information and the second information are generated as FEC packets independent from the supplied media packets.

6. The method according to claim 1, wherein both the first information and the second information are respectively added to the supplied media packets corresponding thereto.

7. An FEC decoding method, comprising:
sequentially storing payloads each included in sequentially received media packets into first locations in a buffer memory;
sequentially storing information for FEC received to be attached to a group of the media packets into second locations in the buffer memory different from the first locations;
detecting number of packets of the group of the media packets from the information for FEC stored into the second locations in the buffer memory;
detecting whether a loss occurs in a portion of the payloads to be stored into the first locations in the buffer memory when a corresponding number of payloads to the number of packets detected are stored into the first locations in the buffer memory; and
performing FEC operation, when the loss occurs in the portion of the payloads to be stored into the first locations in the buffer memory, using existing payloads stored into the first locations in the buffer memory and the information for FEC stored into the second locations in the buffer memory to recover the loss.

8. An FEC decoding apparatus, comprising:
a buffer memory;
a first control unit configured to store payloads each included in sequentially received media packets into first locations in the buffer memory;
a second control unit configured to sequentially store information for FEC received to be attached to a group of the media packets into second locations in the buffer memory different from the first locations;
a third control unit configured to detect number of packets of the group of the media packets from the information for FEC stored into the second locations in the buffer memory;
a fourth control unit configured to detect whether a loss occurs in a portion of the payloads to be stored into the first locations in the buffer memory when a corresponding number of payloads to the number of packets detected are stored into the first locations in the buffer memory; and
a fifth control unit configured to perform FEC operation, when the loss occurs in the portion of the payloads to be stored into the first locations in the buffer memory, using existing payloads stored into the first locations in the buffer memory and the information for FEC stored into the second locations in the buffer memory to recover the loss.

9. The apparatus according to claim 8, wherein the fifth control unit is configured to pad a dummy payload into the first location in the buffer memory where the loss has not occurred and no payload has been stored and performs the FEC operation using the existing payloads together with the dummy payload and the information for FEC.
